(19) United States
(12) Patent Application Publication
(10) Pub. No.: US 2009/0237405 A1
(43) Pub. Date: Sep. 24, 2009

(54) DATA PROCESSING APPARATUS AND DATA PROCESSING METHOD

(75) Inventors: Kimio Hayashi, Tokushima-shi (JP); Josuke Iwata, Tokushima-shi (JP); Shintaro Kuronuma, Tokushima-shi (JP); Naoki Shibata, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JustSystems Corporation, Tokushima-shi (JP)

(21) Appl. No.: 12/396,914

(22) Filed: Mar. 3, 2009

(30) Foreign Application Priority Data
Mar. 3, 2008 (JP) 2008-051644

(51) Int. Cl. G06T 11/20

(52) U.S. Cl. 345/440

(57) ABSTRACT

In a data processing apparatus, a processor of an S88 processing unit comprises: a display unit that displays a diagram including a plurality of figures representing a processing unit and a connecting line representing a processing flow by connecting the plurality of figures together; an editing unit that executes, when receiving an editing command to edit the diagram from a user via a screen displayed by the display unit, the editing thus requested; and a link control unit that determines, when the editing unit receives an editing command to connect a first figure representing start or end of branched processing with a second figure representing a processing unit by using a connecting line, a point on a line forming the second figure, to which the connecting line is to be connected, such that one end of the connecting line is automatically connected, and that also connects, when receiving from the user a specification that specifies any position on a line to which the connecting line is to be connected among lines forming the first figure, the other end of the connecting line with the position specified by the user.

### BACKGROUND OF THE INVENTION

1. Field of the Invention

The present invention relates to a document processing technique, more particularly, to a data processing apparatus and method for processing a diagram representing a processing flow.

2. Description of the Related Art

XML attracts attention as a form suitable for sharing data with others via a network, etc., and applications for creating, displaying and editing XML documents are developed (for example, see Patent Document 1). An XML document is created based on a vocabulary (tag set) defined by document type definition, etc.

[Patent Document 1] Japanese Patent Application Laid-open No. 2001-290804.

XML is also suitable for expressing a diagram representing a processing flow. The present applicant has developed a technique capable of appropriately processing a diagram by using an XML document in which such flexible designing is allowed. And, the applicant has finally contemplated a data processing technique capable of improving a user's convenience in processing a diagram.

### SUMMARY OF THE INVENTION

The present invention has been made in view of these circumstances, and a purpose of the invention is to provide a technique for appropriately processing a diagram.

An embodiment of the present invention relates to a data processing apparatus. The data processing apparatus comprises: a display unit that displays a diagram including a plurality of figures representing a processing unit and a connecting line representing a processing flow by connecting the plurality of figures together; an editing unit that executes, when receiving an editing command to edit the diagram from a user via a screen displayed by the display unit, the editing thus requested; and a link control unit that determines, when the editing unit receives an editing command to connect a first figure representing start or end of branched processing with a second figure representing a processing unit by using a connecting line, a point on a line forming the second figure, to which the connecting line is to be connected, such that one end of the connecting line is automatically connected, and that also connects, when receiving from the user a specification that specifies any position on a line to which the connecting line is to be connected among lines forming the first figure, the other end of the connecting line with the position specified by the user.

Another embodiment of the present invention relates to a data processing method. The data processing method comprises: displaying a diagram including a plurality of figures representing a processing unit and a connecting line representing a processing flow by connecting the plurality of figures together; executing, when receiving an editing command to edit the diagram from a user via a screen displayed by the display unit, the editing thus requested; and determining, when receiving an editing command to connect a first figure representing start or end of branched processing with a second figure representing a processing unit by using a connecting line, a point on a line forming the second figure, to which the connecting line is to be connected, such that one end of the connecting line is automatically connected, and also connecting, when receiving from the user a specification that specifies any position on a line to which the connecting line is to be connected among lines forming the first figure, the other end of the connecting line with the position specified by the user.

Yet another embodiment of the present invention relates to a data processing apparatus. The data processing apparatus comprises: a display unit that displays a diagram including a plurality of figures representing a processing unit and a connecting line representing a processing flow by connecting the plurality of figures together; an editing unit that executes, when receiving an editing command to edit the diagram from a user via a screen displayed by the display unit, the editing thus requested; and a link control unit that connects, when the editing unit receives an editing command to connect a first figure representing start or end of branched processing with a second figure representing a processing unit by using a connecting line, the first figure with the second figure by using the connecting line, wherein the link control unit sets a connecting point where the connecting line is snapped to the first figure, and automatically snaps, when a connecting destination to which the connecting line is to be connected is approximated within a predetermined distance from the connecting point while the user is selecting the connecting destination of the connecting line, one end of the connecting line to the connecting point, and wherein the link control unit newly connects, when the connecting destination is determined, the first figure and the second figure by using a connecting line, and then newly sets a connecting point in the first figure in accordance with the connecting line connected to the first figure or the connecting point set in the first figure.

The link control unit may set new connecting points on both sides of the connecting line thus newly connected. When a connecting point is not set between the connecting line newly connected and the adjacent connecting line or the end point of the first figure, the link control unit may newly set a connecting point between the connecting line thus newly connected and the adjacent connecting line or the end point of the first figure. When there is no connecting point set in the first figure, the link control unit may newly set a connecting point between the connecting lines connected or between the connecting line and the end point of the first figure. When the connecting destination is determined, the link control unit may rearrange the connecting lines connected to the first figure and newly set a connecting point between the connecting lines thus rearranged or between the connecting line and the end point of the first figure.

Yet another embodiment of the present invention relates to a data processing method. The data processing method comprises: displaying a diagram including a plurality of figures representing a processing unit and a connecting line representing a processing flow by connecting the plurality of figures together; executing, when receiving an editing command to edit the diagram from a user via a screen displayed by the display unit, the editing thus requested; and connecting, when receiving an editing command to connect a first figure representing start or end of branched processing with a second figure representing a processing unit by using a connecting line, the first figure with the second figure by using the connecting line, wherein the connecting step includes: setting a connecting point where the connecting line is snapped to the first figure; snapping automatically, when a connecting destination to which the connecting line is to be connected is approximated within a predetermined distance from the connecting point while the user is selecting the connecting destination of the connecting line, one end of the connecting line to the connecting point; and connecting newly, when the connecting destination is determined, the first figure and the second figure by using the connecting line, and then newly setting a connecting point in the first figure in accordance with the connecting line connected to the first figure or the connecting point set in the first figure.

Yet another embodiment of the present invention relates to a data processing apparatus. The data processing apparatus comprises: a display unit that creates a display screen by drawing a plurality of figures arranged on a plane; an editing unit that executes an editing specified by a user with a figure selected by the user being an editing target, among the plurality of figures; a group managing unit that groups, when receiving from the user a command to group a plurality of figures, the plurality of figures selected by the user, and subsequently issues, when any one of the plurality of figures included in the group is selected by the user, a command that all figures included in the group are to be editing targets, to the editing unit, wherein the group managing unit issues, when the user selects any one of the plurality of figures included in the group while performing a certain operation or successively after performing the certain operation, a command that only the selected figure is to be an editing target, to the editing unit.

Yet another embodiment of the present invention relates to a data processing method. The data processing method comprises: creating a display screen by drawing a plurality of figures arranged on a plane; executing an editing specified by a user with a figure selected by the user being an editing target, among the plurality of figures; grouping, when receiving from the user a command to group a plurality of figures, the plurality of figures selected by the user, and subsequently issuing, when any one of the plurality of figures included in the group is selected by the user, a command that all figures included in the group are to be editing targets, to the editing unit; and issuing, when the user selects any one of the plurality of figures included in the group while performing a certain operation or successively after performing the certain operation, a command that only the selected figure is to be an editing target, to the editing unit.

It is noted that any combination of the aforementioned components or any manifestation of the present invention exchanged between methods, devices, systems and so forth, is effective as an embodiment of the present invention.

### BRIEF DESCRIPTION OF THE DRAWINGS

FIG. 1 is a diagram showing a configuration of a document processing apparatus according to Base technology;

FIG. 2 is a diagram showing an example of an XML document that is a processing target;

FIG. 3 is a diagram showing an example in which the XML document shown in FIG. 2 is mapped to a table described in HTML;

FIG. 4A is a diagram showing an example of a definition file used for mapping the XML document shown in FIG. 2 to the table shown in FIG. 3;

FIG. 4B is a diagram showing an example of a definition file used for mapping the XML document shown in FIG. 2 to the table shown in FIG. 3;

FIG. 5 is a diagram showing an example of a screen on which the XML document shown in FIG. 2 is displayed after having been mapped to HTML according to the correspondence shown in FIG. 3;

FIG. 6 is a diagram showing an example of a graphical user interface provided by a definition file creating unit, which allows the user to create a definition file;

FIG. 7 is a diagram showing another example of a screen layout created by the definition file creating unit;

FIG. 8 is a diagram showing an example of an editing screen for an XML document, as provided by the document processing apparatus;

FIG. 9 is a diagram showing another example of an XML document that is to be edited by the document processing apparatus;

FIG. 10 is a diagram showing an example of a screen on which the document shown in FIG. 9 is displayed;

FIG. 11 is a diagram showing the configuration of the data processing apparatus according to the embodiment;

FIG. 12 is a diagram showing the internal configuration of the processor of the S88 processing unit;

FIG. 13 is a diagram showing an example of a screen displayed by the S88 processing unit;

FIG. 14 is a diagram showing an example of a screen displayed by the S88 processing unit;

FIG. 15 is another example of a screen displayed by the S88 processing unit;

FIG. 16 is another example of a screen displayed by the S88 processing unit;

FIGS. 17A to 17E are diagrams showing the states where a connecting point to which a connecting line is connected is automatically updated;

FIGS. 18A to 18E are diagrams showing the states where a connecting point to which a connecting line is connected is automatically updated;

FIGS. 19A to 19E are diagrams showing the states where a connecting point to which a connecting line is connected is automatically updated;

FIG. 20 is a diagram for explaining a function of the group managing unit;

FIG. 21 is a diagram for explaining a function of the group managing unit;

FIG. 22 is a diagram for explaining a function of the group managing unit; and

FIG. 23 is a diagram for explaining a function of the group managing unit.

### DETAILED DESCRIPTION OF THE INVENTION

The invention will now be described by reference to the preferred embodiments. This does not intend to limit the scope of the present invention, but to exemplify the invention.

### (Base Technology)

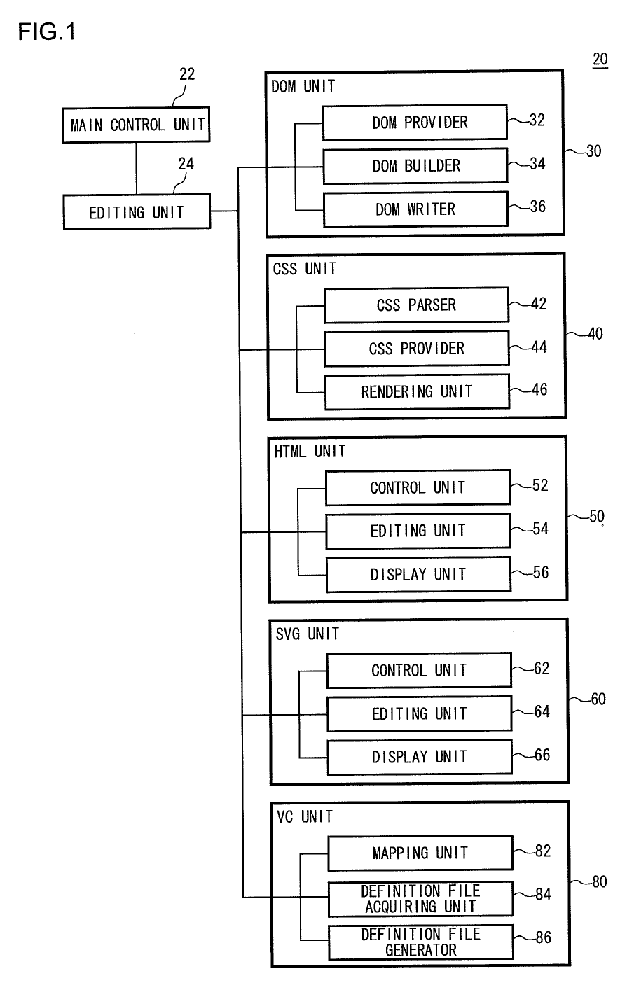

FIG. 1 shows a configuration of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 that serves as an example of a conversion unit. In terms of hardware components, these unit structures may be realized by any conventional processing system or equipment, including a CPU or memory of any computer, a memory-loaded program, or the like. Here, the drawing shows a functional block configuration that is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a namespace of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above configuration, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this configuration is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an editing unit (also designated herein as a “zone”) 54 and 64, which edits the DOM according to the editing commands. Upon the control unit 52 or 62 receiving a DOM tree editing command from an external source, the editing unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the editing units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC) In the VC unit 80, the definition file acquiring unit 84 acquires a script file in which the mapping definition is described. Here, the definition file specifies the correspondence (connection) between the nodes for each node. Furthermore, the definition file may specify whether or not editing of the element values or attribute values is permitted. Furthermore, the definition file may include operation expressions using the element values or attribute values for the node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface that allows the user to create a definition file.

The VC unit 80 monitors the connection between the source tree and the destination tree. Upon reception of an editing instruction from the user via a user interface provided by a plug-in that handles a display function, the VC unit 80 first modifies a relevant node of the source tree. As a result, the DOM unit 30 issues a mutation event indicating that the source tree has been modified. Upon reception of the mutation event thus issued, the VC unit 80 modifies a node of the destination tree corresponding to the modified node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a namespace of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary that is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

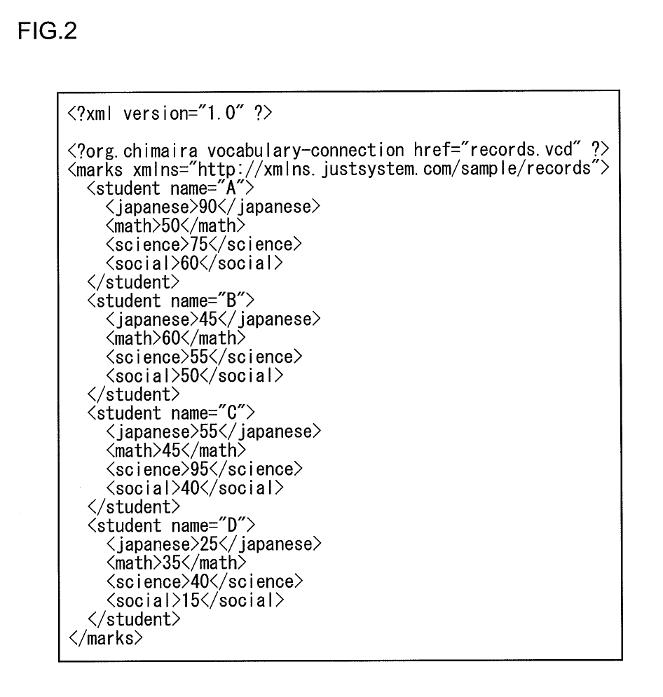

FIG. 2 shows an example of an XML document to be processed. According to this exemplary illustration, the XML document is used to manage data concerning grades or marks that students have earned. A component “marks”, which is the top node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science”and “social-studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. It is noted that description will be made later regarding a user interface that allows the user to create the user's own definition file. Now, description will be made below regarding a case in which a definition file has already been prepared.

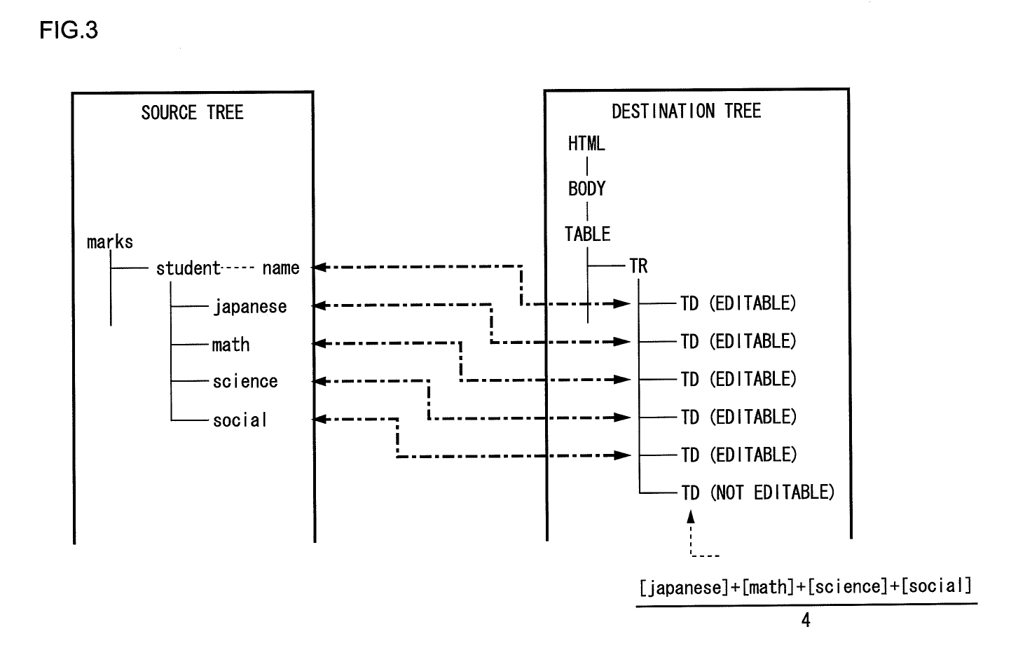

FIG. 3 shows an example in which the XML document shown in FIG. 2 is mapped to a table described in HTML. In an example shown in FIG. 3, a “student” node in the marks managing vocabulary is associated with a row (“TR” node) of a table (“TABLE” node) in HTML. The first column in each row corresponds to an attribute value “name”, the second column to a “japanese” node element value, the third column to a “mathematics” node element value, the fourth column to a “science” node element value and the fifth column to a “social-studies” node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

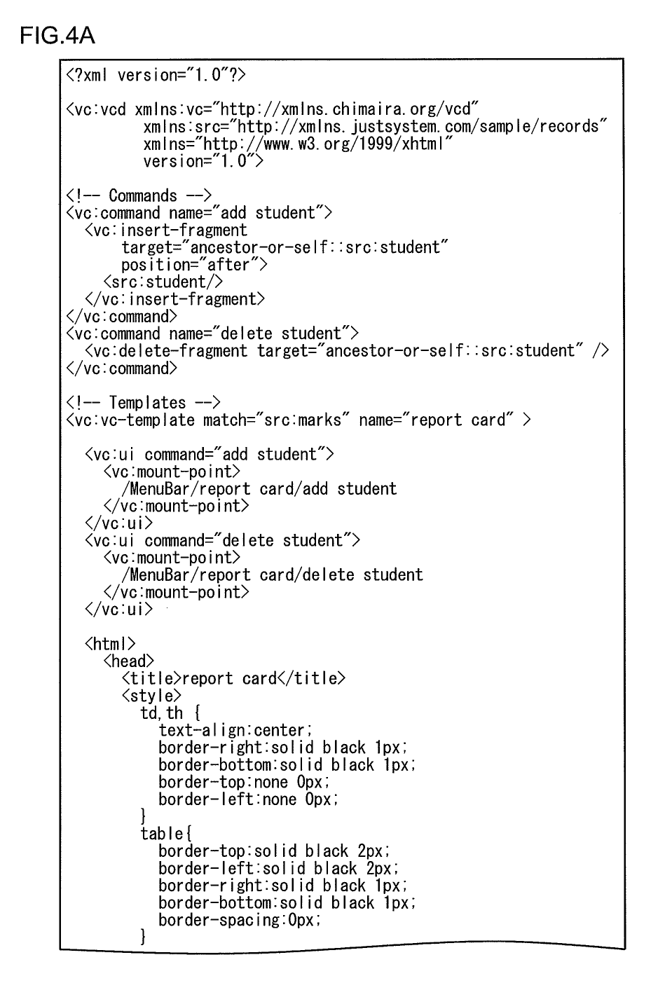

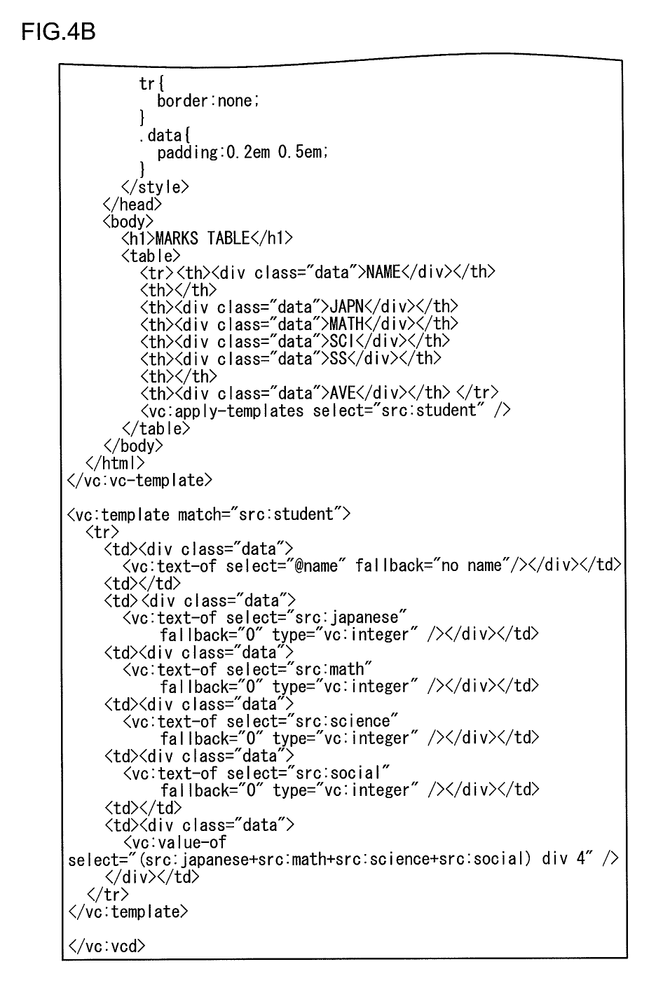

FIG. 4A and FIG. 4B illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4A and FIG. 4B, “add student” and “delete student” are defined as commands, and an operation of inserting a node “student” into a source tree and an operation of deleting the node “student” from the source tree, respectively, are associated with these commands. Furthermore, the definition file is described in the form of a template, which describes that a header, such as “name” and “japanese”, is displayed in the first row of a table and the contents of the node “student” are displayed in the second and subsequent rows. In the template displaying the contents of the node “student”, a term containing “text-of” indicates that editing is permitted, whereas a term containing “value-of” indicates that editing is not permitted. Among the rows where the contents of the node “student” are displayed, an operation expression “(src:japanese+src:mathematics+scr:science+scr:social_studies) div 4” is described in the sixth row. This means that the average of the student's marks is displayed.

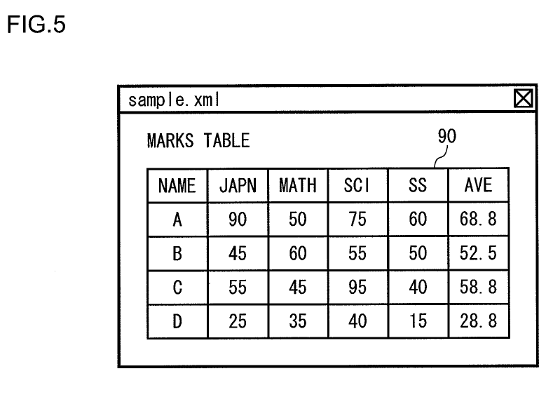

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4A and FIG. 4B. When the user selects a command from among these commands, a node “student” is added or deleted in the source tree. In this manner, with the document processing apparatus 20 according to the Base Technology, it is possible not only to edit the element values of components in a lower end of a hierarchical structure but also to edit the hierarchical structure. An editing function for editing such a tree structure may be presented to the user in the form of commands. Furthermore, a command to add or delete rows of a table may, for example, be linked to an operation of adding or deleting the node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

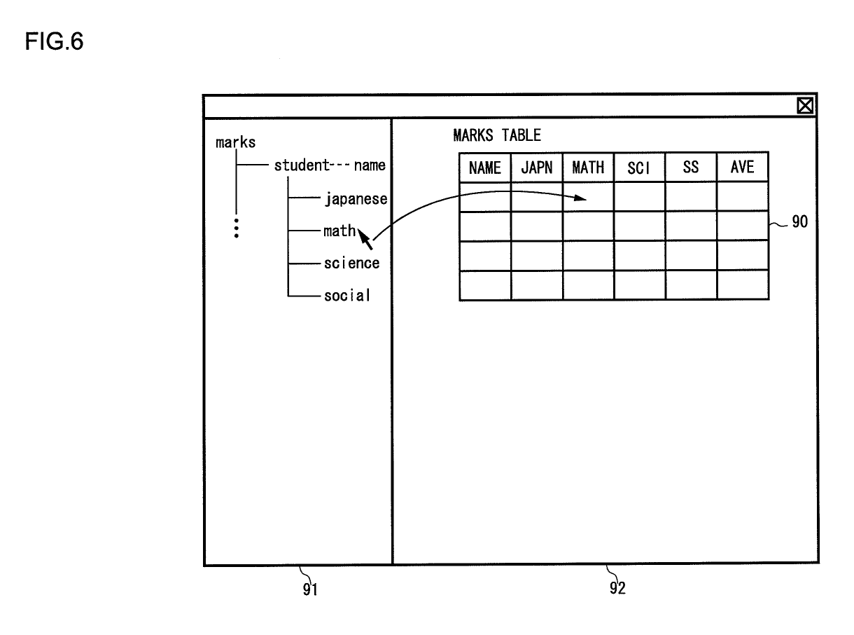

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a node of the XML document that is to be mapped, which is displayed in the left-hand area 91 of the screen, is dragged and dropped into HTML screen layout in the right-hand area 92 of the screen using a pointing device such as a mouse, so that a connection between a node at a mapping source and a node at a mapping destination is specified. For example, when “mathematics,” which is a child element of the element “student,” is dropped to the intersection of the first row and the third column in a table 90 on HTML screen, a connection is established between the “mathematics” node and a “TD” node in the third column. Either editing or no editing can be specified for each node. Moreover, the operation expression can be embedded in a display screen. When the screen editing is completed, the definition file generator 86 creates definition files, which describe connections between the screen layout and nodes.

Viewers or editors that can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

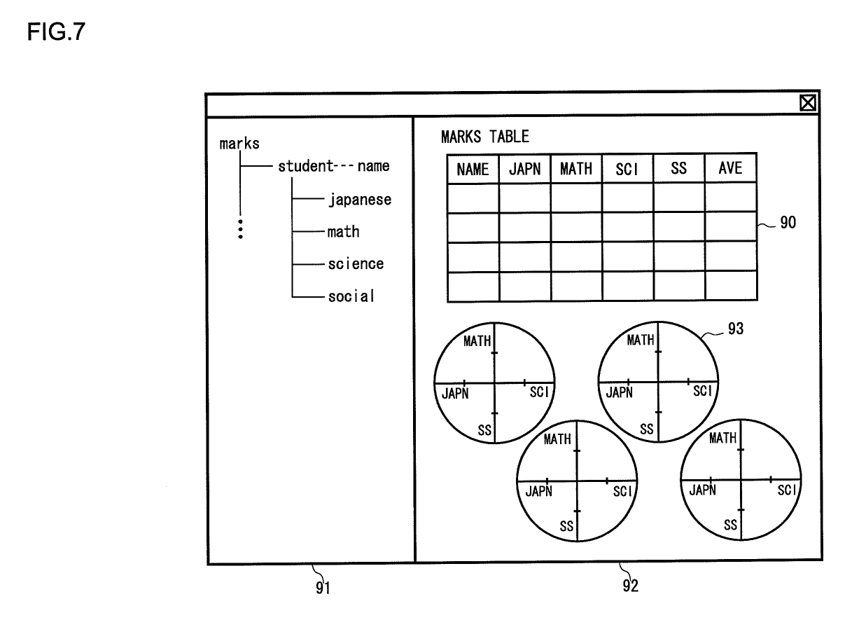

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

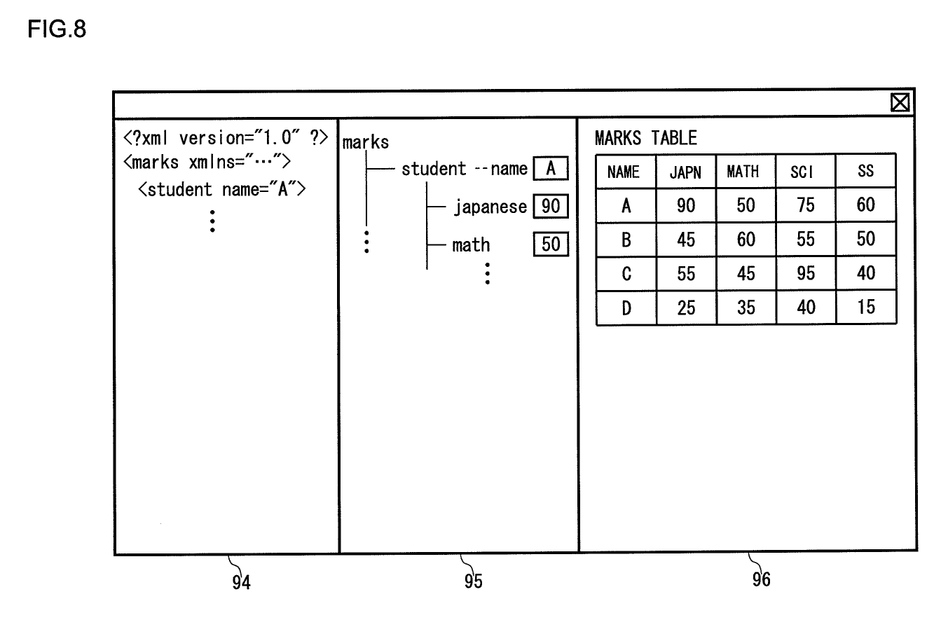

FIG. 8 shows an example of a display medium, which in a preferred but non-limiting embodiment is an editing screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective editing screens are registered in advance as listeners for mutation events that provide notice of a change in the source tree. When the source tree is modified by any of the plug-ins or the VC unit 80, all the display units, which are displaying the editing screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

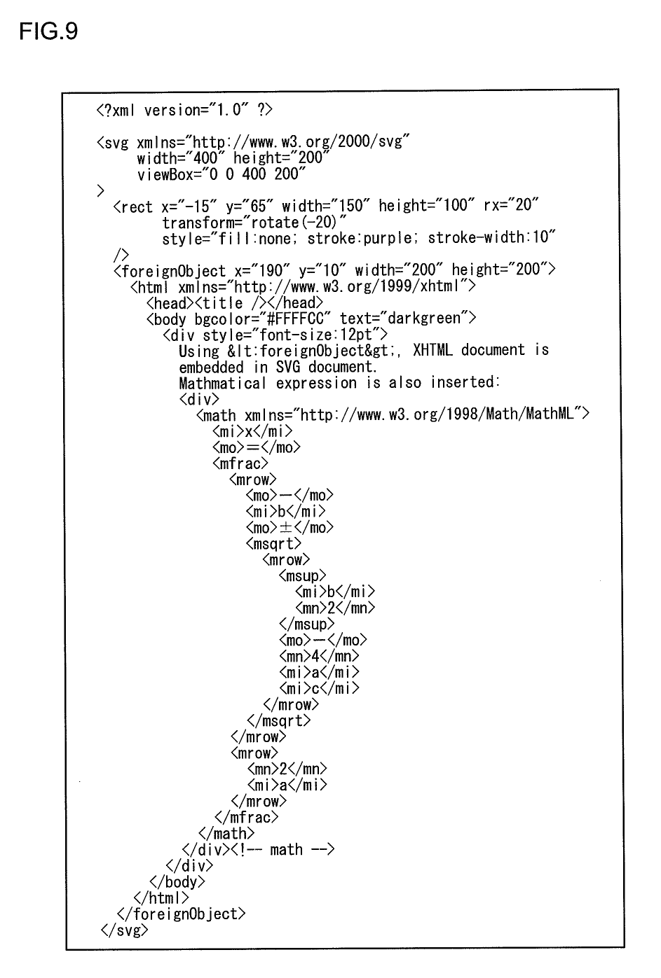

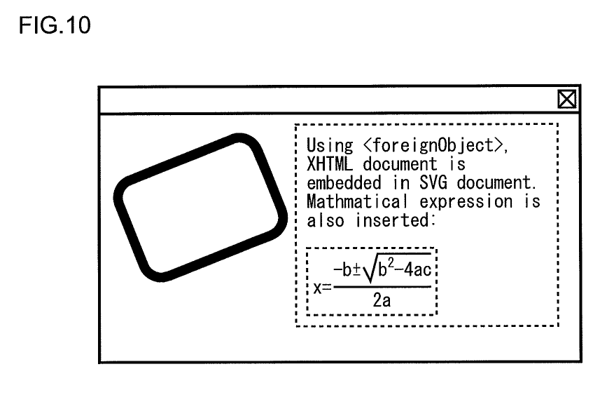

FIG. 9 illustrates another example of an XML document edited by the document processing apparatus 20. In the XML document shown in FIG. 9, an XHTML document is embedded in a “foreign object” tag of an SVG document, and the XHTML document contains an equation described in MathML. In this case, the editing unit 24 assigns the rendering job to an appropriate display system by referring to the namespace. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set that is defined in the definition file for mapping the SVG document, is displayed. On the other hand, when the cursor lies in an area where the XHTML document is displayed, the menu provided by HTML unit 50, or a command set that is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an editing screen as shown in FIG. 10, a plug-in or a VC unit 80, which is in charge of processing the edited portion, modifies the source tree. A listener for mutation events can be registered for each node in the source tree. Normally, a display unit of the plug-in or the VC unit 80 conforming to a vocabulary that belongs to each node is registered as the listener. When the source tree is modified, the DOM provider 32 traces toward a higher hierarchy from the modified node. If there is a registered listener, the DOM provider 32 issues a mutation event to the listener. For example, referring to the document shown in FIG. 9, if a node that lies lower than the <html> node is modified, the mutation event is notified to HTML unit 50, which is registered as a listener to the <html> node. At the same time, the mutation event is also notified to the SVG unit 60, which is registered as a listener in an <svg> node, which lies upper to the <html> node. At this time, HTML unit 50 updates the display by referring to the modified source tree. Since the nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest node, in increments of display regions that are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### Embodiments

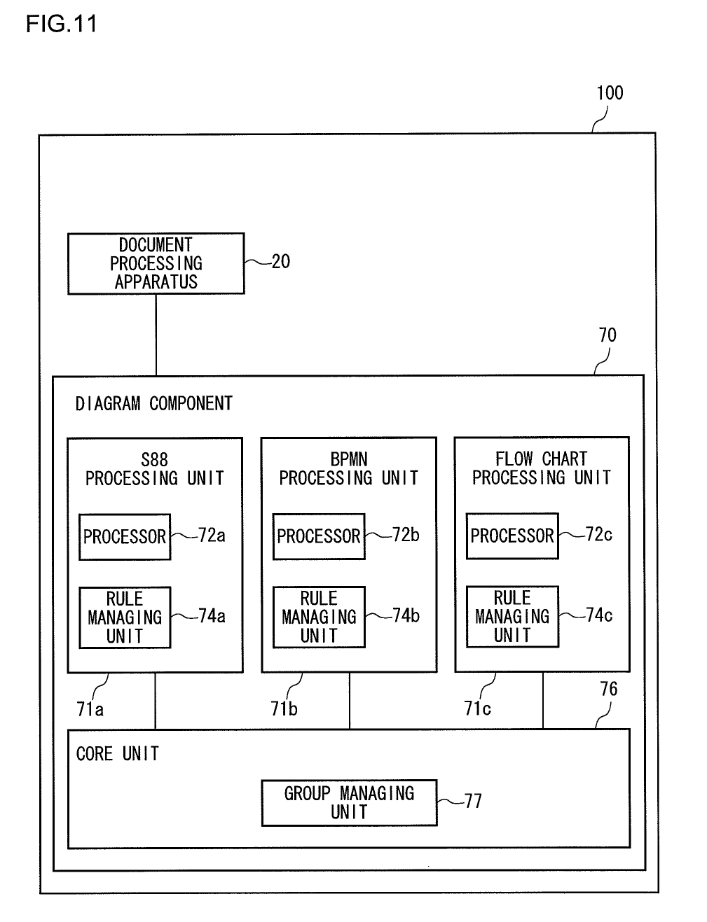

FIG. 11 is a diagram showing the configuration of the data processing apparatus 100 according to the embodiment. The data processing apparatus 100 comprises a diagram component 70 in addition to the configuration of the document processing apparatus 20 according to Base Technology shown in FIG. 2. The diagram component 70 provides a function of displaying and editing a diagram. The diagram component 70 comprises a plurality of processing units 71 that perform processing in accordance with each of multiple notations for notating a diagram, and a core unit 76 that provides a function commonly used in the multiple notations. In terms of hardware components, these configurations can be implemented by a CPU, memory, program loaded in a memory, etc., of any computer. Herein, functional blocks realized by cooperation of those components are depicted. Accordingly, it should be understood by a person skilled in the art that these functional blocks can be realized in a variety of forms by hardware only, software only or the combination thereof.

The processing unit 71 including the S88 processing unit 71a, the BPMN processing unit 71b and the flow chart processing unit 71c, reads a document in which a diagram is depicted and displays the diagram in accordance with the standard or the notation rule stipulated for creating diagrams, and also edits the diagram when receiving an editing command from a user. The S88 processing unit 71a controls display and editing of diagrams conforming to the S88, the international standard for batch control standardized by the Instrumentation, Systems, and Automation Society (ISA). The BPMN processing unit 71b controls display and editing of diagrams conforming to the Business Process Modeling Notation (BPMN), designed as the graphical standard notation for illustrating and visualizing business processes. The flow chart processing unit 71c controls display and editing of diagrams conforming to the flow chart notation standardized by JIS, etc. Specifications for notating shapes of drawings and arrows, etc., are different from each other according to the respective notations; hence, the processor 72 is provided in accordance with each notation. The processor 72 converts a diagram into data with the use of original XML vocabularies having sufficient information for notating a diagram in each notation, and then processes the data.

The rule managing unit 74 manages editing rules in the processor 72. With respect to diagrams, various restrictions are stipulated by the standards, etc. For example, in the BPMN for notating business models, there is a restriction that “a message flow is not allowed to be used between the activities located in the respective lanes in the same pool”. The rule managing unit 74 holds these editing restrictions to determine the admissibility of editing in the processors 72, supporting creation of a document conforming to each standard. The rule managing unit 74 may be provided as a hard-coded module, or may be configured to be customizable by a parameter file, etc.

The core unit 76 provides a function commonly used by the multiple processors 72, which are provided in accordance with various diagram notations. The core unit 76 provides a common function, which is necessary irrespective of difference between diagram types, in processing a diagram including, for example, operating a DOM and inputting/outputting a file. The group managing unit 77 groups a plurality of figures included in a diagram to manage them. The function of the group managing unit 77 will be described in detail later.

As stated above, by providing the core unit 76 providing a common function, the processor 72 performing processing in accordance with a model for creating a diagram, and the rule managing unit 74 managing editing restrictions, as the separate independent modules, the processor 72 and the rule managing unit 74 can be separately customized in accordance with a diagram type, allowing the data processing apparatus to perform processing flexibly. Furthermore, by collectively organizing the common functions in the core unit 76, the man-hours for development can be reduced, because only the processor 72 and the rule managing unit 74 are to be customized even if a diagram type is different. The processor 72 has an interface for communicating with the core unit 76 and each of the rule managing unit 74, through which performs in collaboration with the core unit 76 and the rule managing unit 74.

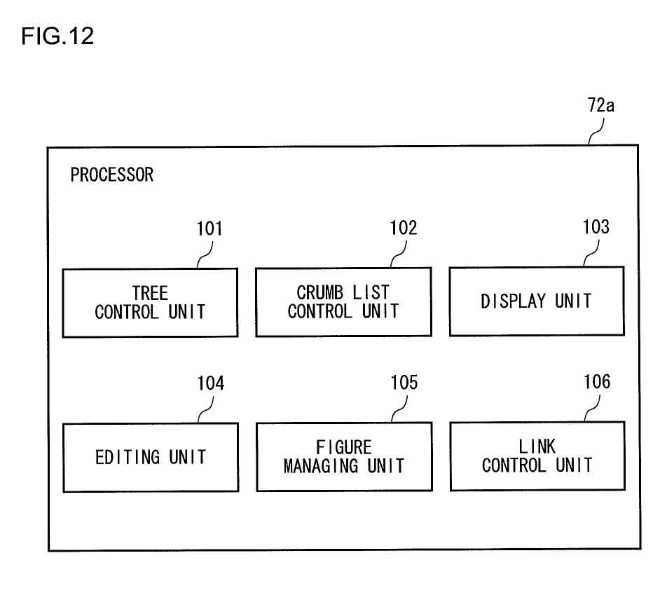

FIG. 12 shows the internal configuration of the processor 72a of the S88 processing unit 71a. The processor 72a comprises a tree control unit 101, a crumb list control unit 102, a display unit 103, an editing unit 104, a figure managing unit 105, and a link control unit 106. These structures can be realized in a variety of forms by hardware only, software only or the combination thereof.

In the S88, the procedures of batch process are hierarchically represented by using processing units such as “Master Recipe”, “Procedure”, “Unit Procedure”, “Operation” and “Phase”. The display unit 103 displays the diagram in the tree specified by a user. The editing unit 104 executes, when receiving from a user an editing command to edit the diagram in the tree displayed by the display unit 103, executes the editing thus requested.

The tree control unit 101 displays in a tree form the hierarchical structure of these processing units included in a batch process. When a user specifies a certain tree in the tree display, the tree control unit 101 makes the display unit 103 display the diagram in the tree. The crumb list control unit 102 displays a crumb list representing the tree displayed by the display unit 103. When the user specifies a certain tree in the crumb list, the crumb list control unit 102 makes the display unit 103 display the diagram in the tree.

The figure managing unit 105 manages a figure that can be arranged within the batch process edited by the editing unit 104. The figure managing unit 105 holds figured shape data of the figures in the S88, which represent processing units such as “Master Recipe”, “Procedure”, “Unit Procedure”, “Operation”, “Phase”, “Parallel Divergent” and “Parallel Convergent”, and figures representing “processing” “input/output” “preparation” and “decision” in a flow chart; and displays these figures on the screen. When the user performs an operation of dragging a displayed figure and dropping the figure on the screen for displaying a diagram displayed by the display unit 103, the figure managing unit 105 communicates the figure handled and the position where the figure is dropped, to the editing unit 104 to arrange the figure in the tree displayed.

The link control unit 106 controls a linear-type or hook-type link together connecting a plurality of figures representing processing units arranged in a batch process. The functions of the link control unit 106 will be described in detail later.

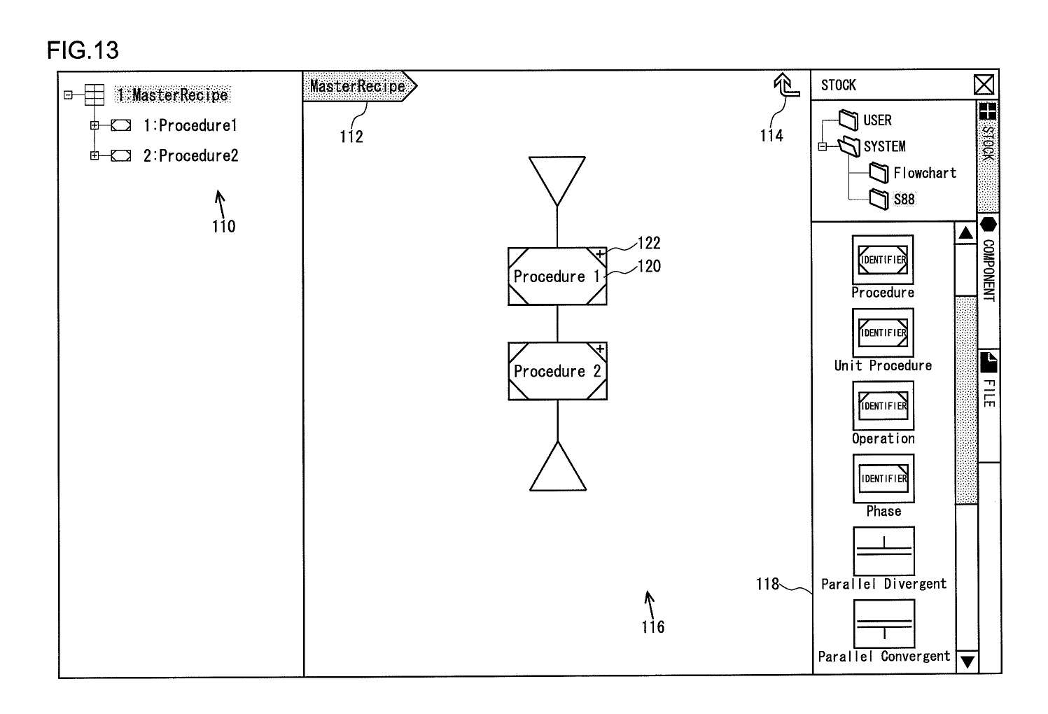

FIG. 13 shows an example of the screen displayed by the S88 processing unit 71a. On the display screen, there are provided a main screen 116 where a diagram in a specific tree in a batch process is displayed by the display unit 103, a tree screen 110 where the hierarchical structure of a batch process is displayed in the form of tree display by the tree control unit 101, a crumb list screen 112 where a crumb list representing the tree currently displayed on the main screen 116 is displayed by the crumb list control unit 102, and a stock screen 118 where candidate figures that can be arranged are displayed by the figure managing unit 105.

On the main screen 116, a diagram in the tree selected by a user is displayed in accordance with the S88 specification. In the S88 specification, a figure shape is determined in accordance with a processing unit, the FIG. 120 representing “Procedure” is added with a diagonal line inside each vertex of a rectangle. Likewise, the figure representing “Unit Procedure” is added with diagonal lines inside three vertexes of the upper left, upper right and lower right of a rectangle; the figure representing “Operation” is added with diagonal lines inside two vertexes of the upper left and lower right of a rectangle; and the figure representing “Phase” is added with a diagonal line inside a vertex of the upper right of a rectangle. As seen above, it can de visually decided which processing unit a figure is associated with by the number of diagonal lines added inside the vertexes of a rectangle. In addition, “+” symbol 122 is displayed near the upper right vertex of a rectangle representing a processing unit with a lower tree.

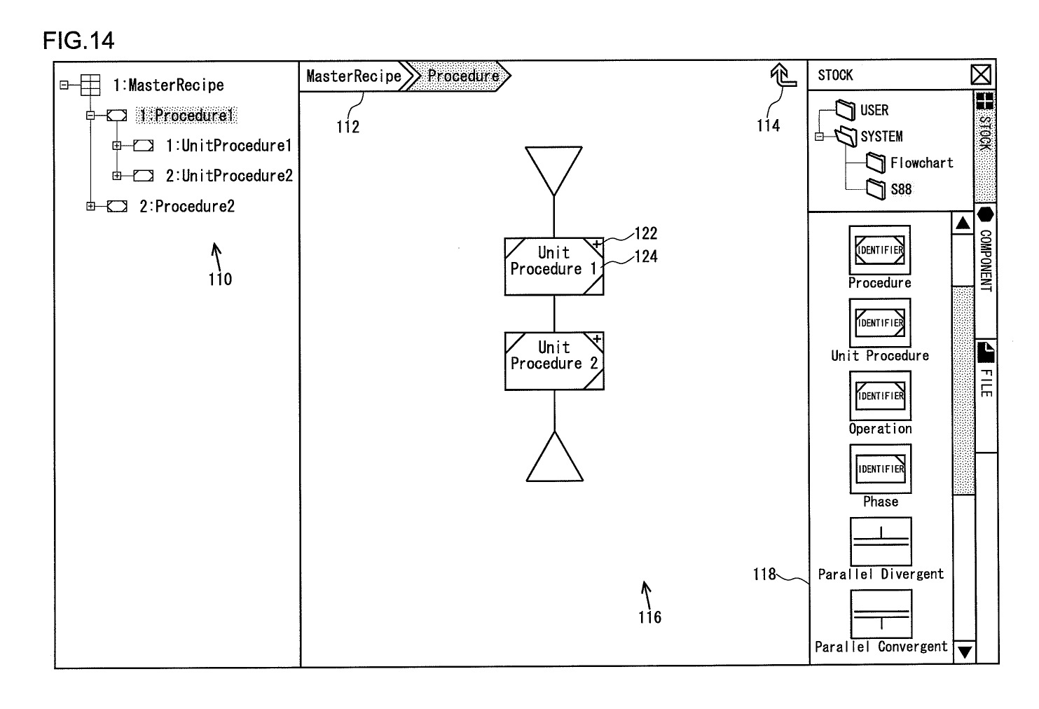

When receiving an operation of double-clicking with a mouse a figure representing a processing unit capable of having a lower tree, the editing unit 104 communicates the display unit 103 to transfer the display to the tree of the processing unit thus specified, allowing the diagram in the tree to be displayed. For example, when receiving an operation of double-clicking the FIG. 120 representing “Procedure”, the display is transferred to the tree associated with “Procedure”. An example of the screen at the time is shown in FIG. 14. When receiving an operation of clicking the “+” symbol 122, the editing unit 104 may transfer the display to the tree where the processing unit associated with the figure added with the “+” symbol 122 is located. Alternatively, when receiving the operation of clicking the “+” symbol 122, the editing unit 104 may deploy the diagram in the tree associated with the symbol, in the diagram currently displayed without transferring trees.

FIG. 14 shows an example of a screen displayed by the S88 processing unit 71a. In FIG. 14, the diagram in the tree associated with “Procedure” is displayed on the main screen 116. The crumb list control unit 102 updates the crumb list screen 112 following transfer of trees. On the screen, the crumb list control unit 102 communicates, when receiving an operation of clicking, for example, “Master Recipe”, the display unit 103 to transfer the display to the tree associated with “Master Recipe”. In addition, the crumb list control unit 102 communicates, when receiving an operation of clicking the arrow 114, the display unit 103 to transfer the display to the tree higher by one.

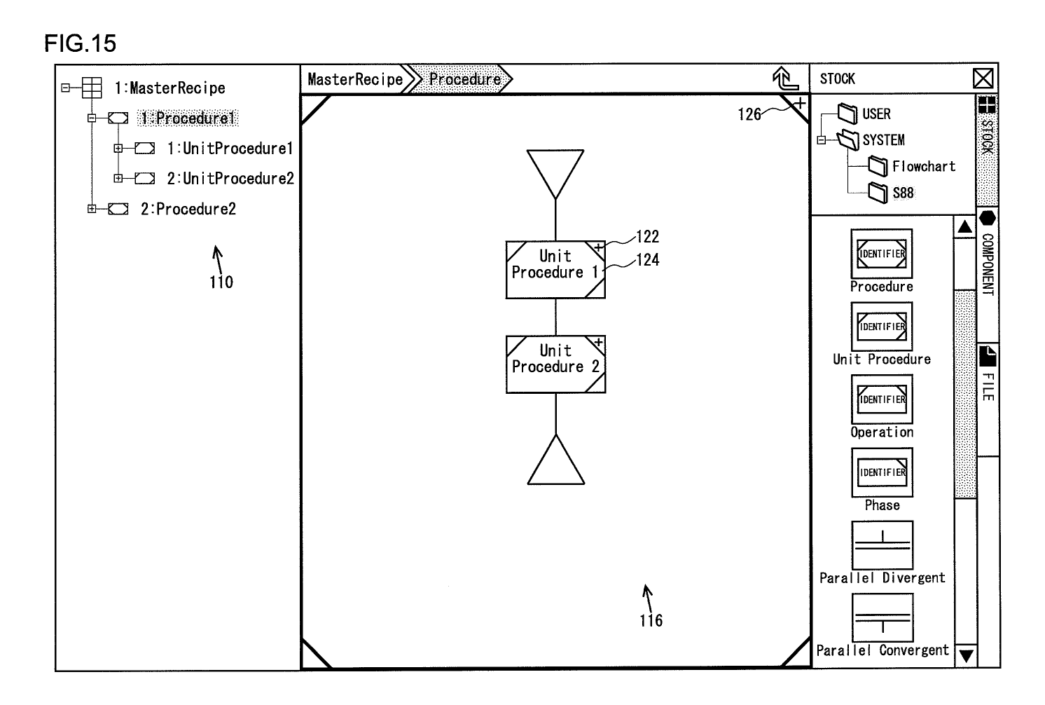

FIG. 15 shows another example of a screen displayed by the S88 processing unit 71a. In the example of FIG. 15, a diagonal line associated with a figure corresponding to a processing unit is displayed inside each vertex of the rectangle representing the area of the main screen 116 by the display unit 103. That is, if the tree currently displayed is “Procedure”, diagonal lines are added inside the four corners of the main screen 116, as shown in FIG. 15; or if the tree is “Unit Procedure”, diagonal lines are added inside the three corners of the upper left, upper right, and lower right of the main screen 116. Thereby, it can be displayed in a visually easy-to-understand manner which processing unit the tree currently displayed is associated with. When the tree currently displayed has a lower tree, the display unit 103 may display the “+” symbol 126 inside the upper right vertex of the main screen 116. In this case, when receiving an operation of clicking the “+” symbol 126, the editing unit 104 may communicate the display unit 103 to transfer the display to the lower tree.

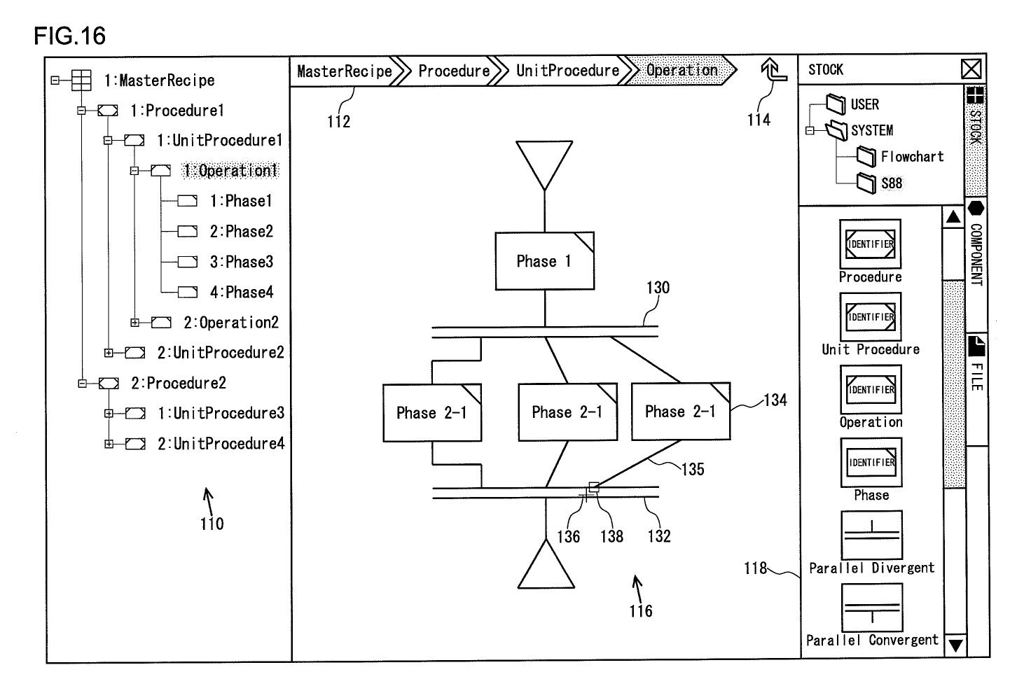

FIG. 16 shows another example of a screen displayed by the S88 processing unit 71a. In the example of FIG. 16, the FIG. 130 associated with “Parallel Divergent” representing start of branched processing and the FIG. 132 associated with “Parallel Convergent” representing end of the branched processing, are arranged on the main screen 116. The link control unit 106 allows, when connecting the FIG. 130 associated with “Parallel Divergent” or the FIG. 132 associated with “Parallel Convergent”, with another figure, for example, the FIG. 134 associated with “Phase 2-1” by using the connecting line 135, the connecting line 135 to be connected to any position on a horizontal straight line included in the FIG. 130 associated with “Parallel Divergent” or the FIG. 132 associated with “Parallel Convergent”. Typically, when setting a connecting line between figures, the link control unit 106 automatically connects the connecting line to a preset position on the line, for example, to the center of each side of the specified figure. When a plurality of links are set in the same figure, the link control unit 106 automatically connects the connecting line by calculating positions where the side to which the connecting line is connected is equally divided. With respect to “Parallel Divergent” or “Parallel Convergent”, however, the number of divisions is not determined, therefore it is considered that user's convenience is improved by a measure that a connecting line can be connected to the positions the user desires rather than snapping the connecting line to equally-divided positions, etc., determined in a fixed manner. Accordingly, in the present embodiment, a function in which a connecting line is connected to any position on a line is provided, allowing a user to specify any position on the line.

In FIG. 16, while a user is performing an editing operation for arranging the connecting line 135, the link control unit 106 displays the FIG. 138 representing a snap position on a straight line to which the connecting line 135 is to be connected, near the pointer 136 operated by the user in the FIG. 132 associated with “Parallel Convergent”. When the user transfers the pointer 136 from side to side, the link control unit 106 transfers the FIG. 138 representing the snap position from side to side on the straight line, in accordance with the transfer of the pointer 136. When the user determines a position of the pointer 136, the link control unit 106 connects the connecting line 135 to the position of the FIG. 138 at the time.

When connecting a connecting line with the FIG. 130 associated with “Parallel Divergent” or the FIG. 132 associated with “Parallel Convergent”, the link control unit 106 may snap the connecting line to a position calculated in accordance with the number of connecting lines already connected to the figure. For example, when a user intends to connect a fourth connecting line with the FIG. 130 associated with “Parallel Divergent”, with which three connecting lines are already connected, the link control unit 106 may automatically connect the four connecting lines to the respective points on the straight line to which the connecting line is to be connected after calculating four positions equally-diving the line into 5.

A connecting line is conventionally snapped and connected to a connecting point that is determined in advance in a fixed manner. In the case, however, when intending to connect a certain number of connecting lines, which is larger than the number of connecting points prepared in advance, a plurality of connecting lines are to be connected to the same connecting point, resulting in a difficulty of distinguishing the connecting lines from each other. Accordingly, in the present embodiment, a technique in which connecting points are automatically updated in accordance with the number of connecting lines will be described in detail below.

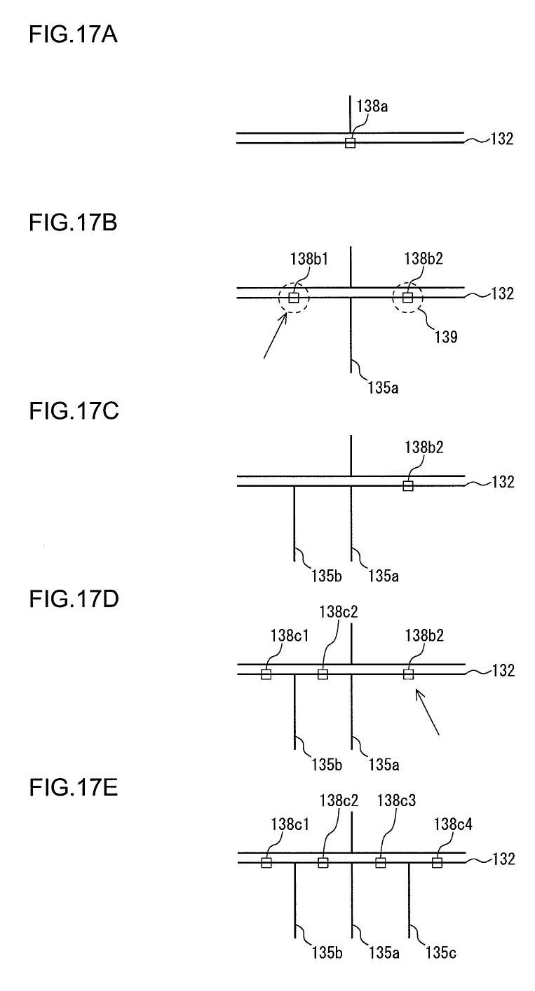

FIGS. 17A to 17E are diagrams showing the states where a connecting point to which a connecting line is connected is automatically updated. When there is no connecting line connected to the FIG. 132, the link control unit 106 provides a connecting point 138a at the midpoint of a straight line to which the connecting line is to be connected, as shown in, for example, FIG. 17A. In the initial state, any number of connecting points may be provided at any position on the straight line.

The state where a connecting line 135a is connected to the connecting point 138a in the state of FIG. 17A is shown in FIG. 17B. When the connecting line 135a is connected to the connecting point 138a, there is no connecting point to which a connecting line is not connected (unconnected point); hence, the connecting line next-to-be connected is to be overlapped at the connecting point 138a. Therefore, the link control unit 106 newly provides the connecting points 138b1 and 138b2. The link control unit 106 may set a new connecting point at the midpoint between the end point of the straight line and the connecting point 138a to which the connecting line is connected, or set a new connecting point spaced a certain distance from the end point of the straight line or the connecting point 138a. It is desirable that the two connecting points 138b1 and 138b2 are provided at the symmetric positions with respect to the connecting point 138a. In the example of FIG. 17B, a total of two connecting points are provided on both sides of the connecting point 138a; however, the link control unit 106 may newly provide three or more of connecting points when a connecting line is connected to a connecting point.

A snap area 139 is provided around each connecting point, which allows the link control unit 106 to automatically snap one end of a connecting line to the connecting point when a user drags the one end of the connecting line to the inside of the snap area 139. For example, when the user drags the one end of the connecting line near the connecting point 138b1, and then drops the end of the connecting line while the connecting point 138b1 snapping it, the link control unit 106 connects the connecting line 135b with the connecting point 138b1. The state is shown in FIG. 17C.

In the state shown in FIG. 17C, since the connecting point 138b2 remains unconnected, the link control unit 106 is not needed to newly provide a connecting point; however, it is possibly inconvenient when intending to connect a connecting line to a position from the left side of the FIG. 132. Therefore, the link control unit 106 may newly provide connecting points on both sides of the connecting line 135b thus newly connected. For example, as shown in FIG. 17D, the midpoints between the connecting point 138b1 to which the connecting line 135b is connected and the end of the straight line and between the connecting point 138b1 and the connecting point 138a next thereto, may be set as the new connecting points 138c1 and 138c2.

The state where a connecting line 135c is connected to the connecting point 138b2 in the state of FIG. 17D is shown in FIG. 17E. The link control unit 106 provides new connecting points 138c3 and 138c4 on both sides of the connecting point 138b2 to which the connecting line 135c is connected. Due to this, it can be prevented that a plurality of connecting lines are overlapped with the same connecting line, because a connecting points is newly provided when the number of the connecting lines is increased; hence, an easy-to-read diagram can be created.

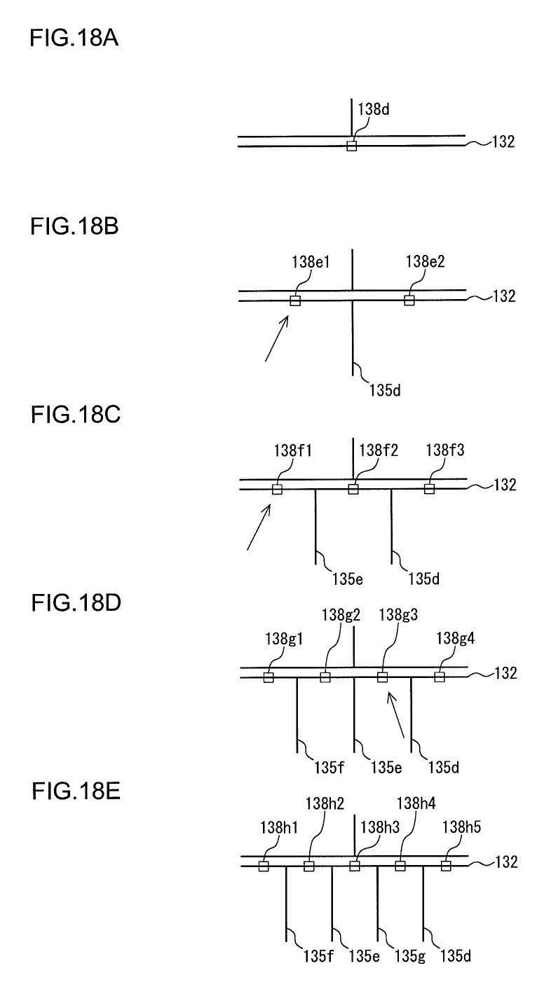

FIGS. 18A to 18E are diagrams showing the states where a connecting point to which a connecting line is connected is automatically updated. FIGS. 18A to 18E show an example in which a position of a connecting line to which a connecting line is connected is also automatically updated in accordance with the number of the connecting lines. Assuming that the number of connecting lines which are already connected is n, the link control unit 106 connects each connecting line to each point equally dividing the straight line into (n+1); and sets, among the points equally dividing the straight line into 2(n+1), the point to which no connecting line is connected as a new connecting point. For example, when n=0, the point dividing the line into two is set as a connecting point 138d as shown in FIG. 18A; and when n=1, the point dividing the line into two is connected with the connecting line 135d, and among the points dividing the line into four, ¼ and ¾ positions are set as the connecting points 138e1 and 138e2, respectively.

In the state shown in FIG. 18B, when a user drags one end of a connecting line near the connecting point 138e1, the link control unit 106 automatically snaps the one end of the connecting line to the connecting point 138e1. Due to this, it can be prevented that the connecting line is overlapped with another connecting line while the user is dragging the one end of the connecting line. Subsequently, when the user drops the connecting line, the link control unit 106 rearranges the two connecting lines 135d and 135e into the points equally-dividing the line into three; and sets, among the points equally-dividing the line into six, ⅙, 3/6 , and ⅚ positions as new connecting points 138f1, 138f2, and 138f3. The state is shown in FIG. 18C.

When the connecting line 135f is further connected to the connecting point 138f1 in the state of FIG. 18C, the three connecting lines are rearranged in the order of 138f, 138e and 138d from left of the points dividing the line into four as shown in FIG. 18D. When the connecting line 135g is further connected to the connecting point 138g3 in the state of FIG. 18D, the four connecting lines are rearranged in the order of 138f, 138e, 138g and 138d from left of points equally-dividing the line into 5 as shown in FIG. 18E. As seen above, when intending to connect a connecting line, the connecting order of the connecting lines in rearranging them can be readily confirmed by providing a connecting point between each interval made by two neighboring connecting lines.

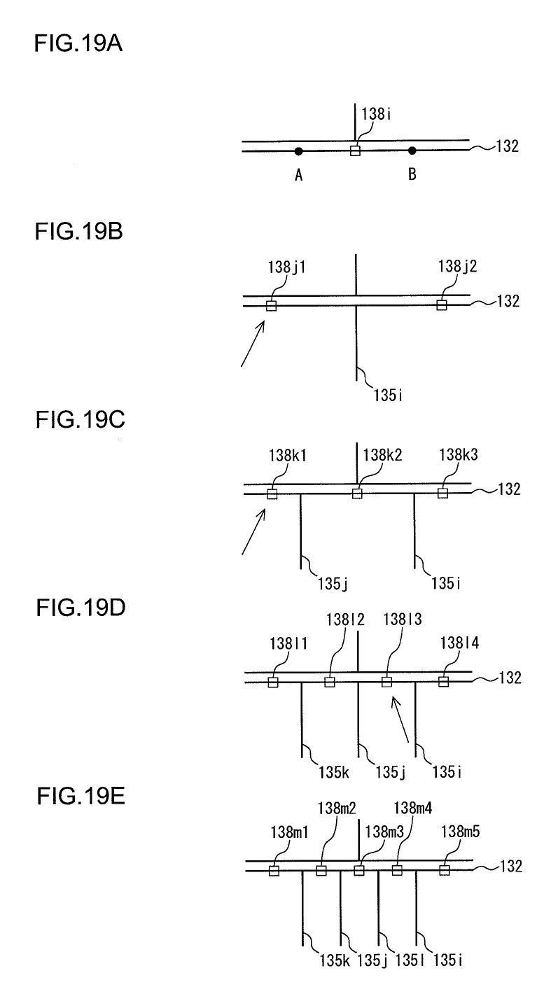

FIGS. 19A to 19E are diagrams showing the states where a connecting point to which a connecting line is connected is automatically updated. In FIGS. 19A to 19E, connecting points are determined by equally-dividing part of the straight line, which is made by excluding from the straight line a certain margin provided on both ends of the straight line, rather than the points equally-dividing the whole straight line. Namely, as shown in FIG. 19A, assuming that positions A and B, respectively spaced a certain distance from the both ends of the straight line, are the standard positions, positions to which connecting lines are to be connected and positions of connecting points are calculated.

At first in the state shown in FIG. 19A, when the connecting line 135i is connected to the connecting point 138i, the link control unit 106 connects the connecting line 135i to the point equally-diving the line AB into two, and provides the connecting points 138jand 138j2 on both sides of the connecting line 135i. Successively, when the connecting line 135j is connected to the connecting point 138jl, the link control unit 106 connects the connecting lines 135i and 135j on both ends of the line AB; and then provides the connecting point 138k1 between the left end of the straight line and the point A, the connecting point 138k2 at the midpoint of the line AB, and the connecting point 138k3 between the right end of the straight line and the point B, respectively.

When the connecting line 135k is further connected to the connecting point 138k1, the link control unit 106 connects the connecting lines 135k, 135j and 135i, to the point A, the midpoint of the line AB and the point B, respectively; and provides connecting points 13811, 13812, 13813 and 13814 between the left end of the straight line and the point A, ¼ and ¾ positions among four positions equally-dividing the line AB into four, and between the right end of the straight line and the point B, respectively.

When the connecting line 135l is further connected to the connecting point 13813, the link control unit 106 connects the connecting lines 135k, 135j, 135l, and 135i in this order, to the point A, two positions equally-dividing the line AB into three, and the point B, respectively; and provides the connecting points 138m1, 138m2, 138m3, 138m4 and 138m5 between the left end of the straight line and point A, at ⅙, 3/6 and ⅚ positions among positions equally-dividing the line AB into six, and between the right end of the straight line and the point B, respectively.

Subsequently, the link control unit 106 connects the connecting lines to the end points of the line AB and to the points equally-dividing the line AB into (n−1); and provides connecting points between the left end point of the straight line and the point A, at the unconnected positions among the positions equally-dividing the line AB into 2(n−1) and between the right end of the straight line and the point B, respectively, in the same manner as previous one.

The example of “Parallel Divergent” and “Parallel Convergent” representing parallel processing has been described with reference to FIG. 16. The description is also true for “Sequence Divergent” and “Sequence Convergent” representing sequential processing. User's convenience can be improved by providing these functions.

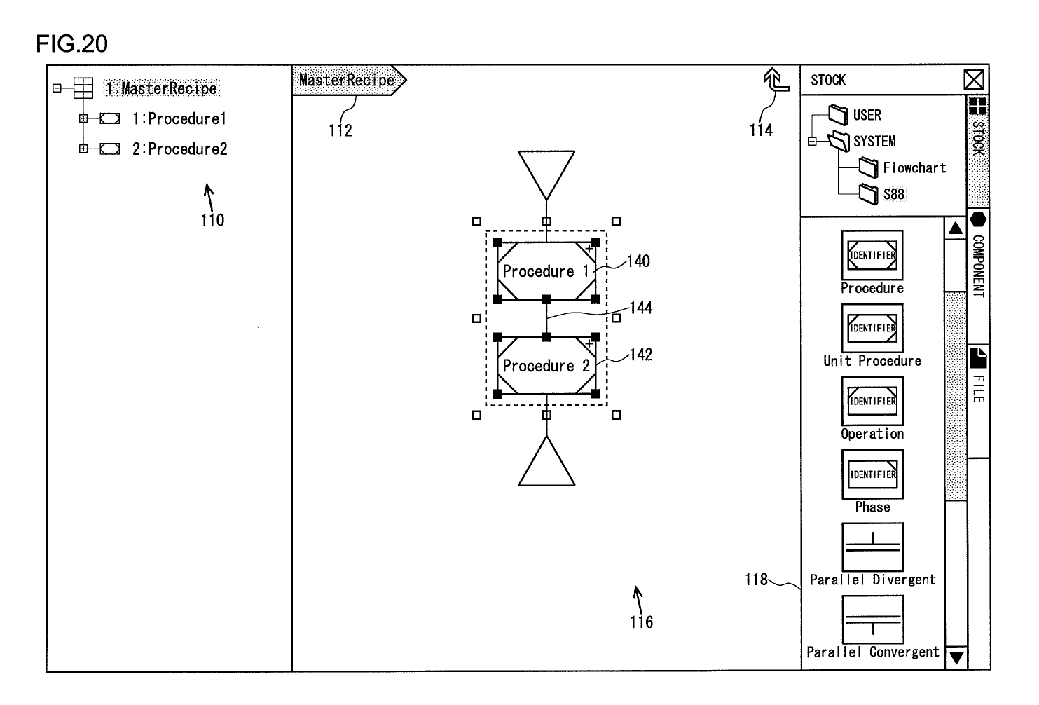

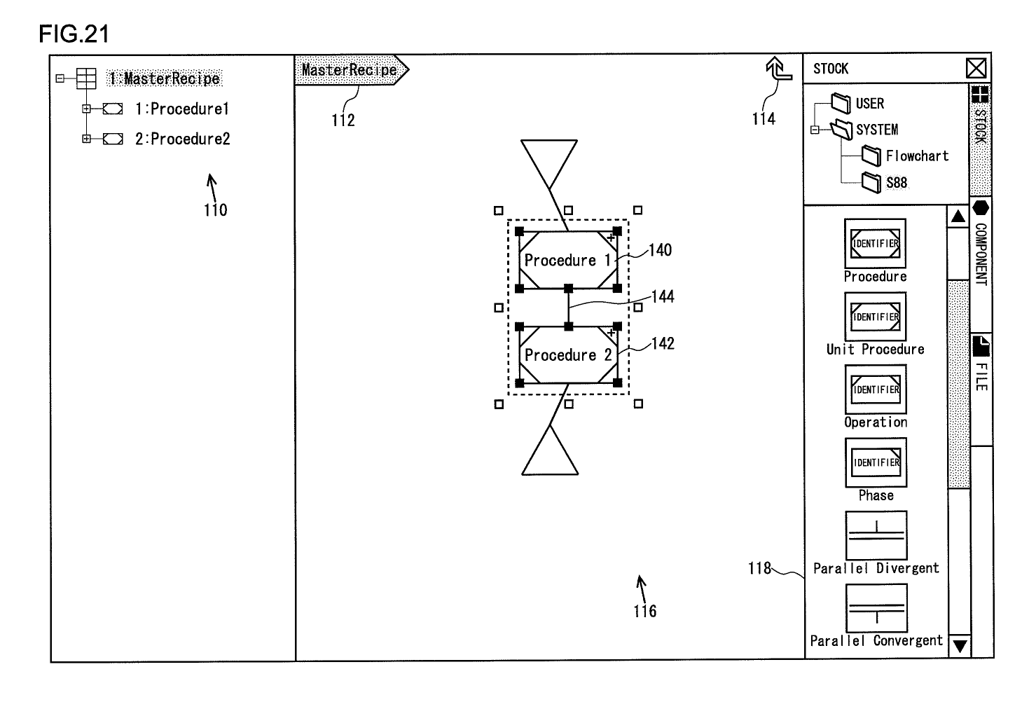

FIGS. 20 to 23 are diagrams for explaining the function of the group managing unit 77. As shown in FIG. 20, when a user performs an operation for selecting a rectangle 140, a rectangle 142 and a connecting line 144 to group them with the use of a mouse, the group managing unit 77 groups these figures. When any one of a plurality of figures included in the group is selected, the group managing unit 77 issues an command that all figures included in the group are to be editing targets, to the editing unit 104. When an editing operation such as enlargement, contraction, rotation and transfer of a figure, is performed, the editing unit 104 applies the editing operation to all of the figures included in the group. For example, when a user selects any one of the rectangle 140, the rectangle 142 and the connecting line 144 to transfer it to the right, all of the rectangle 140, rectangle 144 and connecting line 144, which are included in the group, are transferred to the right, as shown in FIG. 21.

In conventional graphic drawing software, etc., when a user desires to edit only part of the grouped figures, it is needed that the user once cancels the grouping of the figures and selects the figure, an editing target, to edit it. However, according to the present embodiment, even when figures are grouped, only part of the figures included in the group can be selected and edited by performing a certain operation. The certain operation may be one in which the figure is clicked while pressing down a function key or a certain key, for example, the “Alt” key, “Ctrl” key or “Shift” key, or one in which the figure is clicked successively after the function key is pressed down.

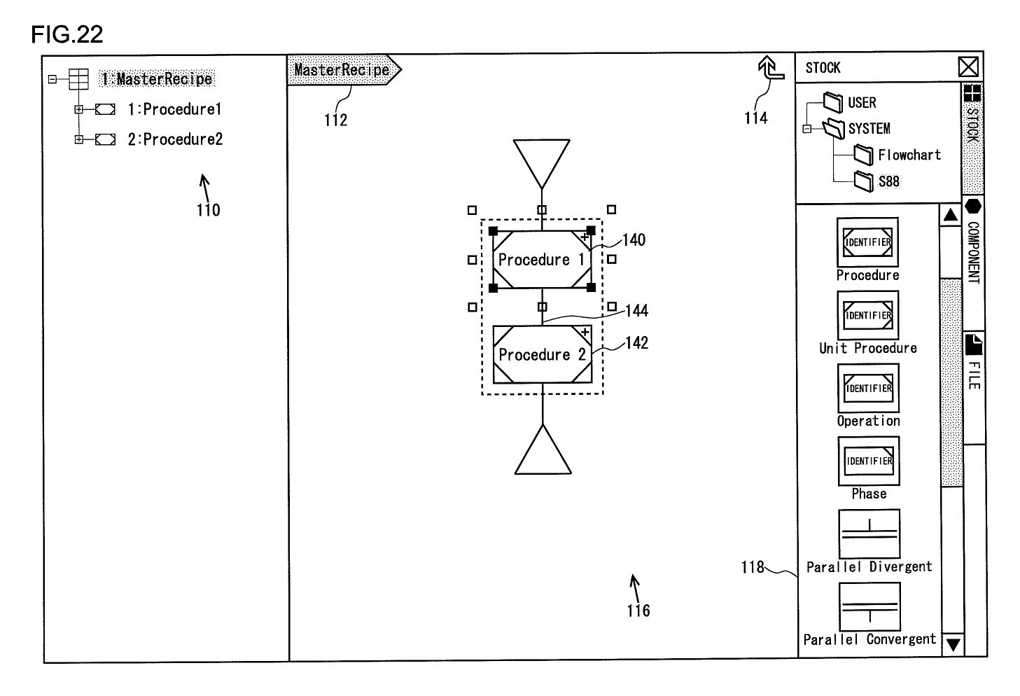

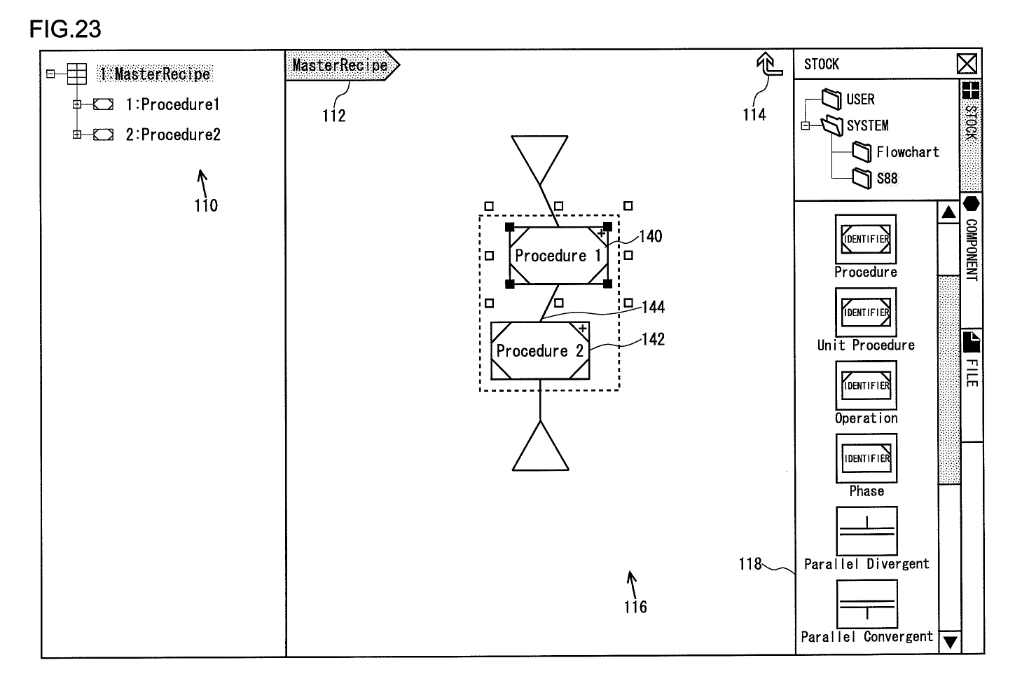

As shown in FIG. 22, when receiving an operation in which the rectangle 140 is clicked while pressing down, for example, the “Alt” key, the group managing unit 77 issues a command that only the rectangle 140 thus clicked is to be selected to the editing unit 104 rather than all of the rectangle 140, rectangle 142 and connecting line 144, which are included in the group, being to be selected. Herein, when the user transfers the rectangle 140 to the right, the editing unit 104 transfers only the rectangle 140 thus selected to the right rather than transferring the whole group, as shown in FIG. 23. As stated above, in the data processing apparatus according to the present embodiment, there is no need that grouping of figures is once cancelled to select and edit part of the figures as well as regrouping the part of the figures thus edited. Accordingly, user's convenience can be improved. The present invention has been described above based on the embodiments thereof. The embodiment has been given solely by way of illustration, and it will be understood by a person skilled in the art that various modifications may be made to combinations of the foregoing components and processes, and all such modifications are also intended to fall within the scope of the present invention.

In the embodiments, examples in which an XML document is processed has been mentioned; however, the data processing apparatus 100 of the present embodiments can process a document described in other markup languages, for example, SGML, HTML etc., as well.

What is claimed is:

1. A data processing apparatus comprising:
a display unit that displays a diagram including a plurality of figures representing a processing unit and a connecting line representing a processing flow by connecting the plurality of figures together;
an editing unit that executes, when receiving an editing command to edit the diagram from a user via a screen displayed by the display unit, the editing thus requested; and
a link control unit that determines, when the editing unit receives an editing command to connect a first figure representing start or end of branched processing with a second figure representing a processing unit by using a connecting line, a point on a line forming the second figure, to which the connecting line is to be connected, such that one end of the connecting line is automatically connected, and that also connects, when receiving from the user a specification that specifies any position on a line to which the connecting line is to be connected among lines forming the first figure, the other end of the connecting line with the position specified by the user.

2. A data processing method executed by a computer comprising:
displaying a diagram including a plurality of figures representing a processing unit and a connecting line representing a processing flow by connecting the plurality of figures together;
executing, when receiving an editing command to edit the diagram from a user via a screen displayed by the display unit, the editing thus requested; and
determining, when receiving an editing command to connect a first figure representing start or end of branched processing with a second figure representing a processing unit by using a connecting line, a point on a line forming the second figure, to which the connecting line is to be connected, such that one end of the connecting line is automatically connected, and also connecting, when receiving from the user a specification that specifies any position on a line to which the connecting line is to be connected among lines forming the first figure, the other end of the connecting line with the position specified by the user.

3. A computer program product comprising:
a module that displays a diagram including a plurality of figures representing a processing unit and a connecting line representing a processing flow by connecting the plurality of figures together;
a module that executes, when receiving an editing command to edit the diagram from a user via a screen displayed by the display unit, the editing thus requested; and
a module that determines, when the editing unit receives an editing command to connect a first figure representing start or end of branched processing with a second figure representing a processing unit by using a connecting line, a point on a line forming the second figure, to which the connecting line is to be connected, such that one end of the connecting line is automatically connected, and that also connects, when receiving from the user a specification that specifies any position on a line to which the connecting line is to be connected among lines forming the first figure, the other end of the connecting line with the position specified by the user.

4. A data processing apparatus comprising:
a display unit that displays a diagram including a plurality of figures representing a processing unit and a connecting line representing a processing flow by connecting the plurality of figures together;
an editing unit that executes, when receiving an editing command to edit the diagram from a user via a screen displayed by the display unit, the editing thus requested; and
a link control unit that connects, when the editing unit receives an editing command to connect a first figure representing start or end of branched processing with a second figure representing a processing unit by using a connecting line, the first figure with the second figure by using the connecting line, wherein the link control unit sets a connecting point where the connecting line is snapped to the first figure, and automatically snaps, when a connecting destination to which the connecting line is to be connected is approximated within a predetermined distance from the connecting point while the user is selecting the connecting destination of the connecting line, one end of the connecting line to the connecting point, and wherein the link control unit newly connects, when the connecting destination is determined, the first figure and the second figure by using a connecting line, and then newly sets a connecting point in the first figure in accordance with the connecting line connected to the first figure or the connecting point set in the first figure.

5. The data processing apparatus according to claim 4, wherein the link control unit sets new connecting points on both sides of the connecting line thus newly connected.

6. The data processing apparatus according to claim 4, wherein, when a connecting point is not set between the connecting line newly connected and the adjacent connecting line or the end point of the first figure, the link control unit newly sets a connecting point between the connecting line thus newly connected and the adjacent connecting line or the end point of the first figure.

7. The data processing apparatus according to claim 4, wherein, when there is no connecting point set in the first figure, the link control unit newly sets a connecting point between the connecting lines connected or between the connecting line and the end point of the first figure.

8. The data processing apparatus according to claim 4, wherein, when the connecting destination is determined, the link control unit rearranges the connecting lines connected to the first figure and newly sets a connecting point between the connecting lines thus rearranged or between the connecting line and the end point of the first figure.

9. A data processing method comprising:
displaying a diagram including a plurality of figures representing a processing unit and a connecting line representing a processing flow by connecting the plurality of figures together;
executing, when receiving an editing command to edit the diagram from a user via a screen displayed by the display unit, the editing thus requested; and
connecting, when receiving an editing command to connect a first figure representing start or end of branched processing with a second figure representing a processing unit by using a connecting line, the first figure with the second figure by using the connecting line, wherein the connecting step includes: setting a connecting point where the connecting line is snapped to the first figure; snapping automatically, when a connecting destination to which the connecting line is to be connected is approximated within a predetermined distance from the connecting point while the user is selecting the connecting destination of the connecting line, one end of the connecting line to the connecting point; and connecting newly, when the connecting destination is determined, the first figure and the second figure by using the connecting line, and then newly setting a connecting point in the first figure in accordance with the connecting line connected to the first figure or the connecting point set in the first figure.

10. A data processing program product comprising:
a module that displays a diagram including a plurality of figures representing a processing unit and a connecting line representing a processing flow by connecting the plurality of figures together;
a module that executes, when receiving an editing command to edit the diagram from a user via a screen displayed by the display unit, the editing thus requested; and
a module that connects, when receiving an editing command to connect a first figure representing start or end of branched processing with a second figure representing a processing unit by using a connecting line, the first figure with the second figure by using the connecting line, wherein the module that connects the first figure and the second figure: sets a connecting point where the connecting line is snapped to the first figure; snaps automatically, when a connecting destination to which the connecting line is to be connected is approximated within a predetermined distance from the connecting point while the user is selecting the connecting destination of the connecting line, one end of the connecting line to the connecting point; and connects newly, when the connecting destination is determined, the first figure and the second figure by using a connecting line, and then newly sets a connecting point in the first figure in accordance with the connecting line connected to the first figure or the connecting point set in the first figure.

11. A data processing apparatus comprising:
a display unit that creates a display screen by drawing a plurality of figures arranged on a plane;
an editing unit that executes an editing specified by a user with a figure selected by the user being an editing target, among the plurality of figures; and
a group managing unit that groups, when receiving from the user a command to group a plurality of figures, the plurality of figures selected by the user, and subsequently issues, when any one of the plurality of figures included in the group is selected by the user, a command that all figures included in the group are to be editing targets, to the editing unit, wherein the group managing unit issues, when the user selects any one of the plurality of figures included in the group while performing a certain operation or successively after performing the certain operation, a command that only the selected figure is to be an editing target, to the editing unit.

12. A data processing method executed by a computer comprising:
creating a display screen by drawing a plurality of figures arranged on a plane;
an editing unit executing an editing specified by a user with a figure selected by the user being an editing target, among the plurality of figures;
grouping, when receiving from the user a command to group a plurality of figures, the plurality of figures selected by the user, and subsequently issuing, when any one of the plurality of figures included in the group is selected by the user, a command that all figures included in the group are to be editing targets, to the editing unit; and
issuing, when the user selects any one of the plurality of figures included in the group while performing a certain operation or successively after performing the certain operation, a command that only the selected figure is to be an editing target, to the editing unit.

13. A computer program product comprising:
a module that creates a display screen by drawing a plurality of figures arranged on a plane;
a module that uses an editing unit to execute an editing specified by a user with a figure selected by the user being an editing target, among the plurality of figures;
a module that groups, when receiving from the user a command to group a plurality of figures, the plurality of figures selected by the user, and subsequently issues, when anyone of the plurality of figures included in the group is selected by the user, a command that all figures included in the group are to be editing targets, to the editing unit; and
a module that issues, when the user selects any one of the plurality of figures included in the group while performing a certain operation or successively after performing the certain operation, a command that only the selected figure is to be an editing target, to the editing unit.
